(19) United States
(12) Patent Application Publication
(10) Pub. No.: US 2026/0308430 A1
(43) Pub. Date: Oct. 8, 2026

(54) LAMINATION ADHESIVE

(71) Applicant: Bostik SA, Puteaux (FR)

(72) Inventors: Marion JARNOUX, VENETTE (FR); Francis PARDAL, VENETTE (FR); Dimitri BAUGNON, VENETTE (FR); Ludwig FAROUX, VENETTE (FR)

(21) Appl. No.: 19/480,148

(22) PCT Filed: Apr. 30, 2024
(86) PCT No.: PCT/FR2024/050559

§ 371 Date: Oct. 30, 2025

(30) Foreign Application Priority Data
May 3, 2023 (FR) FR2304430

(51) Int. Cl. C09J 175/06; C08G 18/10; C08G 18/42; C08G 18/75; C08K 5/544; C09J 5/00; C09J 11/06

(52) U.S. Cl. CPC C09J 175/06; C08G 18/10; C08G 18/425; C08G 18/755; C09J 5/00; C09J 11/06; C08K 5/544; C09J 2475/00

(57) ABSTRACT

The present invention relates to an adhesive composition comprising an —OH component and an —NCO component, characterized in that:
the —NCO component is a composition comprising at least one polyisocyanate;
the —OH component is a composition comprising at least one polyurethane P2 comprising at least one hydroxyl terminal function and at least one silyl terminal function.

### FIELD OF THE INVENTION

The present invention relates to a polyurethane adhesive composition.

The invention also relates to a multilayer structure (or complex) which may be used notably in the field of flexible packaging, which comprises at least two layers of material bonded together by a layer of the crosslinked composition according to the invention.

The present invention also relates to the use of said multilayer structure for the preparation of flexible packaging for food products.

### TECHNOLOGICAL BACKGROUND

Flexible (or supple) packagings intended in particular for the packaging of agrifood products generally consist of several thin layers (in the form of sheets or films), the thickness of which is between 5 and 150 μm, which consist of different materials, such as paper, a metal (for example aluminum) or also by thermoplastic polymers. These thin layers are adhesively bonded together, and the corresponding complex (or multilayer) film, whose thickness may range from 20 to 400 μm, allows the properties of the various individual layers of material (also referred to as “supports”) to be combined, thus offering the consumer a set of characteristics suitable for the final flexible packaging, for instance its visual appearance (notably that of printed elements presenting information relating to the packaged product and intended for the consumer, or its transparency), a barrier effect against light or atmospheric moisture or gases, notably oxygen, contact with food without risk of toxicity or of organoleptic properties of the packaged foods, or appropriate heat resistance (in particular, the adhesive seal formed by crosslinking of the adhesive layer connecting the individual layers of the packaging must retain a sufficient level of cohesion after heat treatment, so as to prevent any delamination).

The various layers of materials of which the multilayer film is composed are typically combined or assembled by laminating during industrial lamination processes. These processes use adhesives (or glues) and items of equipment (or machines) which are designed for this purpose and which operate continuously generally with very high line speeds, of the order of several hundred meters per minute. The multilayer film thus obtained is itself often referred to as a “laminate”.

These lamination processes first of all comprise a step of coating the adhesive over a first film of material, which consists of the deposition of a continuous layer of adhesive with a controlled thickness generally of less than 10 μm, corresponding to an amount of adhesive (or weight per unit area) generally not exceeding 10 g/m². This coating step is followed by a step of laminating a second film of material, which is identical to or different from the first, consisting of the application under pressure of this second film to the first film covered with the layer of adhesive.

The complex films are thus finally obtained in very large width format and are generally conditioned by winding, in the form of wide reels from 1 m to 1.50 m in diameter having, like the film which they store, a width of up to 2 m. These large reels may be stored and transported for use either directly by industrial agrifood manufacturers, for packaging their products, or by converters.

In both cases, the film is cut to reduce its width and is shaped to manufacture sachets, which are themselves intended for the packaging of a product, for example an agrifood product.

Solvent-based two-component polyurethane lamination adhesives are widely used as adhesive for the manufacture of multilayer systems intended for the field of flexible packaging. The use of said solvent-based adhesives in the lamination process necessitates a step of evaporation of the organic solvent. This step is performed before the laminating step by passing through an oven the first film covered with adhesive following the coating step.

The solvent-based two-component polyurethane lamination adhesives are supplied to the laminator in the form of two compositions (or components):
one (known as —NCO component) comprising chemical species bearing isocyanate —NCO end groups, and
the other (known as —OH component) comprising chemical species bearing hydroxyl —OH end groups.

The mixing of these two components may be performed at ambient temperature by the operator of the laminating machine prior to its start-up, which enables correct functioning thereof, by virtue of an appropriate viscosity obtained, where appropriate, by addition of solvent.

On conclusion of the step of coating of the mixture thus obtained on the first thin layer and of the step of laminating of the second layer, the isocyanate groups of the —NCO component react with the hydroxyl groups of the —OH component, according to a reaction referred to as crosslinking, to form a polyurethane which is in the form of a three-dimensional network comprising urethane groups, providing the cohesion of the adhesive seal between the two thin laminated layers.

However, polyurethane-based adhesive compositions generally have the drawback of using a predominantly NCO-terminated NCO component comprising high residual contents of diisocyanate monomers originating from the reaction for the synthesis of the NCO-terminated polyurethane prepolymer. These residual amounts of (“free”) diisocyanate monomers of low molecular mass are capable of migrating through the multilayer film, after the use of the two-component adhesive, and therefore through the final flexible packaging. Thus, said compounds are capable of forming by hydrolysis, on contact with the water or the moisture notably present in packaged foods, primary aromatic amines (PAAs), which are regarded as being very harmful to human health and the environment.

Moreover, certain polyurethane-based adhesive compositions may provide good cohesion before or after heat treatment of a multilayer film containing them. However, such compositions suffer from a problem of performance over time. Specifically, once prepared, the adhesive composition is not necessarily used immediately by laminators to prepare the multilayer system, but is stored for several days or even several months before its use. It is important that the adhesive be just as effective as a “fresh” adhesive (after preparation) even after storage. In particular, it is important that the adhesive be able to produce multilayer structures with good cohesion before and after heat treatment, this being after the adhesive has aged (for example, after the adhesive composition has been stored at 23° C. for one or more months).

There is thus a need for a novel adhesive composition which at least partially addresses at least one of the abovementioned drawbacks.

There is notably a need to provide an adhesive composition leading to a multilayer structure with good resistance to heat treatment, preferably good heat resistance with regard to sterilization and/or pasteurization testing, before and after aging of the adhesive composition.

More particularly, there is a need for novel adhesive compositions which have a good compromise between a reduced level of residual monomers, an ability to crosslink at 23° C., and good adhesive properties before and after heat treatment, even after aging of the adhesive composition.

### DESCRIPTION OF THE INVENTION

### Composition

The present invention relates to an adhesive composition comprising an —OH component and an —NCO component, characterized in that:
the —NCO component is a composition comprising at least one polyisocyanate;
the —OH component is a composition comprising at least one polyurethane P2 comprising at least one hydroxyl terminal function and at least one silyl terminal function.

Preferably, the polyurethane P2 is a polyester polyol-based polyurethane.

In the context of the invention, and unless otherwise mentioned, the term “polyester polyol-based polyurethane” means a polyurethane prepared from at least one polyester polyol, preferably from only polyester polyol(s) as polyol(s).

### —NCO Component

### Polyisocyanate

The polyisocyanate may be chosen from diisocyanates, triisocyanates, and mixtures thereof.

Among the diisocyanates, examples that may be mentioned include the group consisting of isophorone diisocyanate (IPDI), pentamethylene diisocyanate (PDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane diisocyanate (TIN), (2,5)-(TMDI), 4-isocyanatomethyl-1,8-octane bis(isocyanatomethyl)bicyclo[2.2.1]heptane (2,5-NBDI), (2,6)-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl (meta) xylylene diisocyanate), a PDI allophanate (n=5) or HDI allophanate (n=6) having, for example, the formula (Y) below:

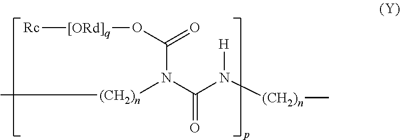

in which p is an integer ranging from 1 to 2, q is an integer ranging from 0 to 9 and preferably 2 to 5, R_{c} represents a saturated or unsaturated, cyclic or acyclic, linear or branched hydrocarbon-based chain comprising from 1 to 20 carbon atoms, preferably from 6 to 14 carbon atoms, R_{d} represents a linear or branched divalent alkylene group containing from 2 to 4 carbon atoms, and preferably a divalent propylene group;
and mixtures thereof.

The diisocyanates are preferably arylaliphatic diisocyanates or cycloaliphatic diisocyanates.

Preferably, the diisocyanates are chosen from isophorone diisocyanate (IPDI), xylylene diisocyanate (XDI) (in particular m-xylylene diisocyanate (m-XDI)) and allophanates 10 of HDI or PDI.

Among the triisocyanates, examples that may be mentioned include isocyanurates, biurets and adducts of diisocyanates and of triols.

The isocyanurates may be used in the form of a technical mixture of (poly) isocyanurate(s) with a purity of greater than or equal to 70% by weight of isocyanurate(s).

Examples of diisocyanate trimers that may be mentioned include:
the isocyanurate trimer of hexamethylene diisocyanate (HDI):

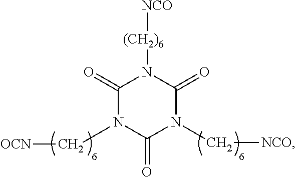

the isocyanurate trimer of isophorone diisocyanate (IPDI):

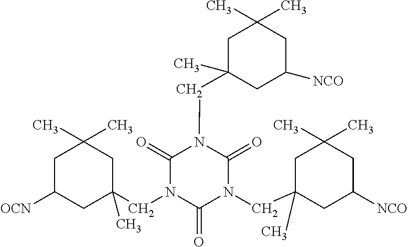

As examples of adducts of diisocyanates and of triols that can be used according to the invention, mention may be made of the adduct of meta-xylylene diisocyanate (m-XDI) with a triol. Such adducts can typically be obtained by addition reaction using said compounds. The methods for such an addition reaction are described, for example, in EP 3 101 044.

The triol used is preferably a trimethylolalkane comprising an alkane comprising from 1 to 20 carbon atoms and 3 methylol groups, such as, for example, trimethylolmethane, trimethylolethane, trimethylolpropane, trimethylol (n-butane), trimethylolisobutane, trimethylol (s-butane), trimethylol (t-butane), trimethylolpentane, trimethylolhexane, trimethylolheptane, trimethyloloctane, trimethylolnonane, trimethyloldecane, trimethylolundecane and trimethyloldodecane.

More preferably, among the triols that can be used to obtain the adduct of m-XDI and of triol, mention may be made of glycerol of formula HOH₂C—CHOH—CH₂OH, trimethylolmethane (TMM) of formula HC(CH₂—OH) 3, trimethylolethane (TME) of formula H₃C—C(CH₂—OH)₃ and trimethylolpropane (TMP) of formula CH₃—CH₂—C(CH₂—OH) 3.

Preferably, the adduct of diisocyanates and triols is the adduct of m-XDI and TMP, having the following formula:

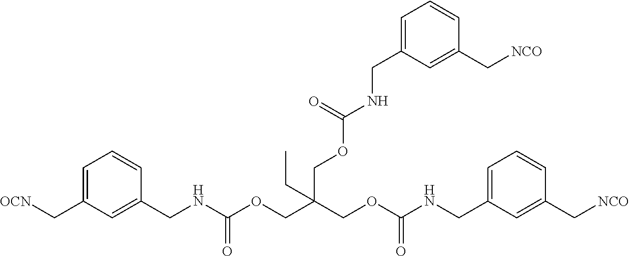

Adducts of m-XDI and of triol are also commercially available.

Mention may be made, for example, of the adduct of m-XDI and of TMP available, as a 75% solution in ethyl acetate, from the company Mitsui Chemicals under the name Takenate® D-110N. The adduct of m-H6XDI and of TMP is also available, as a 75% solution in ethyl acetate, from the company Mitsui Chemicals under the name Takenate® D-120N.

The polyisocyanates are widely available commercially. By way of example, mention may be made of Scuranate® TX sold by the company Vencorex, corresponding to a 2,4-TDI with a purity of about 95%, Scuranate® T100 sold by the company Vencorex, corresponding to a 2,4-TDI with a purity of greater than 99% by weight, and Desmodur® I sold by the company Covestro, corresponding to an IPDI.

Preferably, the polyisocyanate is aliphatic, arylaliphatic or cycloaliphatic polyisocyanate.

Preferably, the polyisocyanate is a triisocyanate, and more preferentially an adduct of m-XDI and triol.

Even more preferably, the polyisocyanate is the adduct of m-XDI and trimethylolpropane (TMP).

### Additives

The —NCO component may comprise at least one additive chosen from the group consisting of plasticizers, catalysts, rheological agents, solvents, pigments, adhesion promoters, moisture absorbers, UV stabilizers (or antioxidants), dyes, fillers, and mixtures thereof.

The —NCO component may comprise at least one solvent, preferably in an amount ranging from 10% to 60% by weight, more preferentially ranging from 15% to 50% by weight and even more preferentially from 20% to 45% by weight, relative to the total weight of the —NCO component.

The solvent may be chosen from organic solvents and alcoholic solvents such as ethyl acetate, methyl ethyl ketone, acetone, xylene, ethanol, isopropanol, tetrahydrofuran, methyltetrahydrofuran or else from Isane® (based on isoparaffins, available from the company Total) or Exxol® D80 (based on aliphatic hydrocarbons, available from the company ExxonMobil Chemical).

Preferably, the —NCO component comprises ethyl acetate.

According to a preferred embodiment, the —NCO component comprises:
from 30% to 90% by weight, more preferentially from 40% to 80% by weight, of polyisocyanate(s) P2) (dry extract);
from 10% to 60% by weight, more preferentially from 15% to 50% by weight, of solvent(s);
   the percentages being weight percentages relative to the total weight of said —NCO component.

The —NCO component can be prepared by simply mixing the ingredients at 23° C., if necessary with stirring.

### —OH Component

The —OH component is a composition comprising at least one polyurethane P2 comprising at least one hydroxyl terminal function and at least one silyl terminal function.

The polyurethane P2 is preferably obtained via a process comprising the following steps:
E1) the preparation of a composition comprising at least one polyurethane P1 comprising at least one-NCO terminal function and at least one-OH terminal function, by a polyaddition reaction of:
   i) at least one polyester polyol A1;
   ii) at least one polyisocyanate P′;
   ii) an optional polyol A2 different from A1;
in amounts such that the NCO/OH mole ratio (r1) is less than 1;
E2) reacting the composition formed in step E1 with at least one aminosilane.

Preferably, in step E2), the reaction takes place in amounts such that the NCO/NH mole ratio (r2) ranges from 1.5 to 5.2 and even more preferentially from 1.5 to 4.5.

### Polyester Polyol A1

Reaction E1) may be performed with a polyester polyol A1 or a mixture of different polyester polyols A1, preferably, in the presence of a mixture of different polyester polyols A1.

The polyester polyol A1 may have a number-average molecular mass Mn greater than or equal to 1000 g/mol.

The polyester polyol polyol A1 may have a number-average molecular mass ranging from 2400 to 12 000 g/mol, preferably greater than or equal to 10 000 g/mol.

The number-average molecular mass Mn is measured by size exclusion chromatography (or SEC), which is also denoted by the term gel permeation chromatography (or GPC). The calibration performed is usually a PEG (PolyEthylene Glycol) or PS (PolyStyrene), preferably PS, calibration.

The hydroxyl number (denoted NOH) of the polyester polyol A1, and more generally of a polyol, (denoted NOH), represents the number of hydroxyl functions per gram of polyol and is expressed in the form of the equivalent number of milligrams of potassium hydroxide (KOH) used in the assaying of the hydroxyl functions, determined by titrimetry, according to the standard ISO 14900:2017. The NOH is related to the number-average molecular mass Mn by the relationship:

NOH=(56.1×f×1000)/Mn

f being the mean functionality of the polyester polyol.

Among the polyester polyols, examples that may be mentioned include:
polyester polyols of natural origin, such as castor oil;
polyester polyols resulting from the polycondensation:
   of one or more aliphatic (linear, branched or cyclic) or aromatic polyols, for instance monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer, and mixtures thereof, with
   one or more polycarboxylic acids or an ester or anhydride derivative thereof, such as 1,6-hexanedioic acid (adipic acid), dodecanedioic acid, azelaic acid, sebacic acid, 1,18-octadecanedioic acid, phthalic acid, isophthalic acid, terephthalic acid, succinic acid, a fatty acid dimer, a fatty acid trimer, and mixtures of these acids, an unsaturated anhydride, for instance maleic or phthalic anhydride, or a lactone, for instance caprolactone;
estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols may be prepared conventionally and are for the most part commercially available.

The polyester polyol A1 is preferably a copolyester obtained via a polycondensation reaction:
of at least one aliphatic diol (a); with
at least one aromatic diacid (b) chosen from terephthalic acid, isophthalic acid, phthalic acid and a diester or anhydride derivative thereof; and mixtures thereof; and
at least one aliphatic diacid (c) or a diester or anhydride derivative thereof.

The aliphatic diol (a) may be linear or branched and is chosen from the group consisting of ethylene glycol (CAS: 107-21-1), diethylene glycol, triethylene glycol, tetraethylene glycol, 1,2-propanediol, dipropylene glycol, tripropylene glycol, tetrapropylene glycol, 1,6-hexanediol, 3-ethyl-2-methyl-1,5-pentanediol, 2-ethyl-3-propyl-1,5-pentanediol, 2,4-dimethyl-3-ethyl-1,5-pentanediol, 2-ethyl-4-methyl-3-propyl-1,5-pentanediol, 2,3-diethyl-4-methyl-1,5-pentanediol, 3-ethyl-2,2,4-trimethyl-1,5-pentanediol, 2,2-dimethyl-4-ethyl-3-propyl-1,5-pentanediol, 2-methyl-2-propyl-1,5-pentanediol, 2,4-dimethyl-3-ethyl-2-propyl-1,5-pentanediol, 2,3-dipropyl-4-ethyl-2-methyl-1,5-pentanediol, 2-butyl-2-ethyl-1,5-pentanediol, 2-butyl-2,3-diethyl-4-methyl-1,5-pentanediol, 2-butyl-2,4-diethyl-3-propyl-1,5-pentanediol, 3-butyl-2-propyl-1,5-pentanediol, 2-methyl-1,5-pentanediol (CAS: 42856-62-2), 3-methyl-1,5-pentanediol (MPD, CAS: 4457-71-0), 2,2-dimethyl-1,3-pentanediol (CAS: 2157-31-5), 2,2-dimethyl-1,5-pentanediol (CAS: 3121-82-2), 3,3-dimethyl-1,5-pentanediol (CAS: 53120-74-4), 2,3-dimethyl-1,5-pentanediol (CAS: 81554-20-3), 2,2-dimethyl-1,3-propanediol (neopentyl glycol-NPG, CAS: 126-30-7), 2,2-diethyl-1,3-propanediol (CAS: 115-76-4), 2-methyl-2-propyl-1,3-propanediol (CAS: 78-26-2), 2-butyl-2-ethyl-1,3-propanediol (CAS: 115-84-4), 2-methyl-1,3-propanediol (CAS: 2163-42-0), 2-benzyloxy-1,3-propanediol (CAS: 14690-00-7), 2,2-dibenzyl-1,3-propanediol (CAS: 31952-16-6), 2,2-dibutyl-1,3-propanediol (CAS: 24765-57-9), 2,2-diisobutyl-1,3-propanediol, 2,4-diethyl-1,5-pentanediol, 2-ethyl-1,6-hexanediol (CAS: 15208-19-2), 2,5-dimethyl-1,6-hexanediol (CAS: 49623-11-2), 5-methyl-2-(1-methylethyl)-1,3-hexanediol (CAS: 80220-07-1), 1,4-dimethyl-1,4-butanediol, 1,5-hexanediol (CAS: 928-40-5), 3-methyl-1,6-hexanediol (CAS: 4089-71-8), 3-(tert-butyl)-1,6-hexanediol (CAS: 82111-97-5), 1,3-heptanediol (CAS: 2343304-7), 1,2-octanediol (CAS: 1117-86-8), 1,3-octanediol (CAS: 23433 May 8), 2,2,7,7-tetramethyl-1,8-octanediol (CAS: 27143-31-3), 2-methyl-1,8-octanediol (CAS: 109359-36-6), 2,6-dimethyl-1,8-octanediol (CAS: 75656-41-6), 1,7-octanediol (CAS: 3207-95-2), 4,4,5,5-tetramethyl-3,6-dioxa-1,8-octanediol (CAS: 76779-60-7), 2,2,8,8-tetramethyl-1,9-nonanediol (CAS: 85018-58-2), 1,2-nonanediol (CAS: 42789-13-9), 2,8-dimethyl-1,9-nonanediol (CAS: 40326-00-9), 1,5-nonanediol (CAS: 13686-96-9), 2,9-dimethyl-2,9-dipropyl-1,10-decanediol (CAS: 85018-64-0), 2,9-dibutyl-2,9-dimethyl-1,10-decanediol (CAS: 85018-65-1), 2,9-dimethyl-2,9-dipropyl-1,10-decanediol (CAS: 85018-64-0), 2,9-diethyl-2,9-dimethyl-1,10-decanediol (CAS: 85018-63-9), 2,2,9,9-tetramethyl-1,10-decanediol (CAS: 35449-36-6), 2-nonyl-1,10-decanediol (CAS: 48074-20-0), 1,9-decanediol (CAS: 128705-94-2), 2,2,6,6,10,10-hexamethyl-4,8-dioxa-1,11-undecanediol (CAS: 112548-49-9), 1-phenyl-1,11-undecanediol (CAS: 109217-58-5), 2-octyl-1,11-undecanediol (CAS: 48074-21-1), 2,10-diethyl-2,10-dimethyl-1,11-undecanediol (CAS: 85018-66-2), 2,2,10,10-tetramethyl-1,11-undecanediol (CAS: 35449-37-7), 1-phenyl-1,11-undecanediol (CAS: 109217-58-5), 1,2-undecanediol (CAS: 13006-29-6), 1,2-dodecanediol (CAS: 1119-87-5), 2,11-dodecanediol (CAS: 33666-71-6), 2,11-diethyl-2,11-dimethyl-1,12-dodecanediol (CAS: 85018-68-4), 2,11-dimethyl-2,11-dipropyl-1,12-dodecanediol (CAS: 85018-69-5), 2,11-dibutyl-2,11-dimethyl-1,12-dodecanediol (CAS: 85018-70-8), 2,2,11,11-tetramethyl-1,12-dodecanediol (CAS: 5658-47-9), 1,11-dodecanediol (CAS: 80158-99-2), 11-methyl-1,7-dodecanediol (CAS: 62870-49-9), 1,4-dodecanediol (CAS: 38146-95-1), 1,3-dodecanediol (CAS: 39516-24-0), 1,10-dodecanediol (CAS: 39516-27-3), 2,11-dimethyl-2,11-dodecanediol (CAS: 22092-59-7), 1,5-dodecanediol (CAS: 20999-41-1), 6,7-dodecanediol (CAS: 91635-53-9), and cyclohexanedimethanol.

Preferably, the diol (a) is chosen from ethylene glycol, diethylene glycol, trimethylene glycol, hexamethylene glycol, propylene glycol (or propane-1,2-diol), propane-1,3-diol, (1,4-, 1,3- or 1,2-) butanediol, neopentyl glycol, 2-methyl-1,3-propanediol, hexanediol or cyclohexanedimethanol.

According to a preferred variant, the diol (a) is chosen from ethylene glycol and diethylene glycol.

Even more preferably, two diols (a) consisting, respectively, of ethylene glycol and diethylene glycol are used.

Among the diester derivatives of terephthalic acid, isophthalic acid or of phthalic acid that may be used as monomers (b), examples that may be mentioned include dimethyl terephthalate or dimethyl isophthalate. As example of an anhydride derivative of an aromatic diacid for the monomer (b), mention may be made of phthalic anhydride.

Preferably, use is made of:
either two diacids (b) consisting, respectively, of terephthalic acid and isophthalic acid;
or isophthalic acid b).

The aliphatic diacid (c) may be linear or branched and is chosen, for example, from adipic acid, azelaic acid, sebacic acid, cyclohexanedicarboxylic acid, dodecanedicarboxylic acid, 1,10-decanedicarboxylic acid and succinic acid.

Preferably, adipic acid is used as aliphatic diacid (c).

According to a preferred embodiment, the polyester polyol A1 is an amorphous polyester polyol.

For the purposes of the invention, and unless otherwise stated, the term “amorphous polyester polyol” means a polyester polyol which is shown not to have a melting point when analyzed by Differential Scanning calorimetry (DSC).

According to a preferred embodiment, the polyester polyol A1 is obtained by polycondensation:
of two aliphatic diols (a) consisting, respectively, of ethylene glycol and diethylene glycol; with
either two diacids (b) consisting, respectively, of terephthalic acid and isophthalic acid; or isophthalic acid as acid b); and
adipic acid as aliphatic diacid (c).

When some among the monomers (b) and optionally (c) are diester derivatives, for instance methyl or ethyl diester derivatives, said monomers are, in a first step, mixed with one or more diol monomers (a), said mixture being brought to a temperature that may range up to 190° C., so as to perform a transesterification reaction, preferably in the presence of a titanium-based or zinc-based catalyst, and to eliminate the methanol or ethanol formed. In a second step, the monomers (b) and optionally (c) which are diacids are added, as a mixture with one or more diol monomers (a), the reaction medium being brought to a temperature that may range up to 230° C., so as to perform the esterification reaction and to eliminate the water formed. Finally, in a third step, the pressure is lowered to a value of less than about 5 mbar and the reaction medium is brought to a higher temperature, which may be up to 250° C., so as to increase the length of the chains of the polyester polyol to achieve a given NOH value.

The polyester polyol A1 may be in dry form or in solvated form. The solvent may be chosen, for example, from the group consisting of esters, ketones and aromatic compounds, and mixtures thereof. The solvent may be chosen, for example, from ethyl acetate, butyl acetate, methyl ethyl ketone, methyl isobutyl ketone, acetone, toluene, xylene and mixtures thereof.

When it is in solvated form, the solids content of the polyester polyol A1 preferably ranges from 40% to 70% by weight (relative to the total weight of solvent and polyester polyol A1).

### Polyisocyanate P′

The polyisocyanate P′ may be as described previously for the —NCO component.

The polyisocyanate P′ may be chosen from diisocyanates, triisocyanates, and mixtures thereof.

Among the diisocyanates, examples that may be mentioned include the group consisting of isophorone diisocyanate (IPDI), pentamethylene diisocyanate (PDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), (2,5)-bis(isocyanatomethyl)bicyclo[2.2.1]heptane (2,5-NBDI), (2,6)-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl (meta) xylylene diisocyanate), a PDI allophanate (n=5) or HDI allophanate (n=6) having, for example, the formula (Y) below:

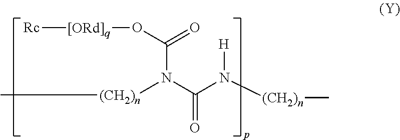

in which p is an integer ranging from 1 to 2, q is an integer ranging from 0 to 9 and preferably 2 to 5, R_{c} represents a saturated or unsaturated, cyclic or acyclic, linear or branched hydrocarbon-based chain comprising from 1 to 20 carbon atoms, preferably from 6 to 14 carbon atoms, R_{d} represents a linear or branched divalent alkylene group containing from 2 to 4 carbon atoms, and preferably a divalent propylene group;
and mixtures thereof.

Preferably, the polyisocyanate P′ is chosen from toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), isophorone diisocyanate (IPDI), xylylene diisocyanate (XDI) (in particular m-xylylene diisocyanate (m-XDI)) and HDI or PDI allophanates.

Even more preferably, the polyisocyanate P′ is isophorone diisocyanate (IPDI).

### Optional Polyol A2

When an optional polyol A2 is used in step E1), its mass content is lower than that of polyester polyol A1 (or the mixture of polyester polyols A1).

The hydroxyl functionality of the polyol A2 may range from 2 to 6. The hydroxyl functionality is the mean number of hydroxyl functions per mole of polyol.

The polyol A2 may be chosen from polyether polyols, polyene polyols, polycarbonate polyols, and mixtures thereof.

The polyether polyols may be chosen from polyoxyalkylene polyols, the linear or branched alkylene portion of which comprises from 1 to 4 carbon atoms, more preferentially from 2 to 3 carbon atoms.

As examples of polyoxyalkylene diols or triols, examples that may be mentioned include:
polyoxypropylene diols or triols (also denoted as polypropylene glycol (PPG) diols or triols) having a number-average molecular mass (Mn) ranging from 300 to 12 000 g/mol;
polyoxyethylene diols or triols (also denoted as polyethylene glycol (PEG) diols or triols) having a number-average molecular mass (Mn) ranging from 300 to 12 000 g/mol;
and mixtures thereof.

The abovementioned polyether polyols may be prepared conventionally and are widely commercially available. They may be obtained by polymerization of the corresponding alkylene oxide in the presence of a basic catalyst (for example potassium hydroxide) or a catalyst based on a double metal/cyanide complex.

As examples of polyether diols, mention may be made of the polyoxypropylene diol sold under the name Voranol® P 400 by the company Dow, with a number-average molecular mass (Mn) in the region of 400 g/mol and the hydroxyl number of which ranges from 250 to 270 mg KOH/g. As examples of polyether triols, mention may be made of the polyoxypropylene triol sold under the name Voranol® CP 450 by the company Dow, with a number-average molecular mass (Mn) in the region of 450 g/mol and the hydroxyl number of which ranges from 370 to 396 mg KOH/g, or the polyoxypropylene triol sold under the name Voranol® CP3355 by the company Dow, with a number-average molecular mass in the region of 3554 g/mol.

The polyene polyols with a molecular mass of greater than 200 g/mol may be chosen from polyenes including hydroxyl end groups, and the corresponding hydrogenated or epoxidized derivatives thereof. The polyene polyols may be chosen from polybutadienes including hydroxyl end groups, which are optionally hydrogenated or epoxidized. Preferentially, the polyene polyol(s) that may be used according to the invention are chosen from butadiene homopolymers and copolymers including hydroxyl end groups, which are optionally hydrogenated or epoxidized.

In the context of the invention, and unless otherwise mentioned, the term “hydroxyl end groups” of a polyene polyol means the hydroxyl groups located at the ends of the main chain of the polyene polyol.

The abovementioned hydrogenated derivatives can be obtained by complete or partial hydrogenation of the double bonds of a polydiene comprising hydroxyl end groups, and are thus saturated or unsaturated.

The epoxidized derivatives mentioned above may be obtained by chemoselective epoxidation of the double bonds of the main chain of a polyene including hydroxyl end groups, and thus include at least one epoxy group in its main chain.

Examples of polyene polyols that may be mentioned include saturated or unsaturated butadiene homopolymers comprising hydroxyl end groups, which are optionally epoxidized, for instance those sold under the name Poly BDR or Krasol® by the company Cray Valley.

The polycarbonate polyols may be chosen from polycarbonate diols or triols, in particular with a number-average molecular mass (Mn) ranging from 300 to 12 000 g/mol.

As example of a polycarbonate diol, mention may be made of Converge® Polyol 212-10 and Converge® Polyol 212-20 sold by the company Novomer, having respective number-average molecular masses (Mn) equal to 1000 and 2000 g/mol, the hydroxyl numbers of which are, respectively, 112 and 56 mg KOH/g.

Preferably, step E1) is not performed with optional polyols A2 (only polyester polyol(s) A1 as polyols).

Preferably, the polyurethane P2 is prepared via a process comprising the following steps: E1) the preparation of a composition comprising at least one polyurethane P1 comprising at least one-NCO terminal function and at least one-OH terminal function, by a polyaddition reaction of:
i) at least one polyester polyol A1;
ii) at least one polyisocyanate P′;
   in amounts such that the NCO/OH mole ratio (r1) is less than 1;
   E2) reacting the composition formed in step E1 with at least one aminosilane.

### Step E1—Synthesis of the Polyurethane P1

During step E1, the polyaddition reaction may be performed at a temperature ranging from 50° C. to 100° C., preferably from 60° C. to 80° C.

In the context of the invention, and unless otherwise mentioned, r1 is the NCO/OH mole ratio corresponding to the mole ratio of the number of isocyanate groups (NCO) to the number of hydroxyl groups (OH) borne by all of the polyisocyanate(s) and polyol(s) present in the reaction medium of step E1.

Preferably, the ratio r1 ranges from 0.25 to 0.95 and even more preferentially from 0.40 to 0.80.

The polyaddition reaction of step E1 may be performed in the presence or absence of at least one reaction catalyst.

The catalyst can be any catalyst known to those skilled in the art for catalyzing the formation of polyurethane by reaction of at least one polyisocyanate with at least one polyol.

An amount ranging up to 0.3% by weight of catalyst(s), relative to the weight of the reaction medium of step E1, may be used.

The reaction of step E1 may also be performed in the presence of a solvent. The solvent may be chosen from the group consisting of esters, ketones and aromatic compounds, and mixtures thereof. The solvent may be added during step E1 or may come from the starting reagents dissolved in said solvent. The solvent may be chosen, for example, from the group consisting of esters, ketones and aromatic compounds, and mixtures thereof. The solvent may be chosen, for example, from ethyl acetate, butyl acetate, methyl ethyl ketone, methyl isobutyl ketone, toluene, xylene and mixtures thereof.

Polyurethane P1 is preferably a polyester polyol-based polyurethane.

The polyurethane P1 preferably has a content of NCO groups ranging from 0.10% to 0.90%, more preferentially from 0.15% to 0.75%.

Step E1 preferably leads to a composition comprising at least one polyurethane P1 as described in the present patent application, in admixture with other polymer(s), such as a prepolymer terminated with at least two OH functions.

Step E2 is advantageously performed before the disappearance of polyurethane P1 (before all the —NCO functions have reacted).

Step E2 is advantageously performed without isolating polyurethane P1.

Polyurethane P1 typically has a lower number-average molecular mass than polyurethane P2.

### Step E2—Synthesis of the Polyurethane P2

Step E2 may be performed at a temperature of less than 95° C., for example between 40° C. and 80° C.

In the context of the invention, and unless otherwise mentioned, r2 is the NCO/NH mole ratio corresponding to the mole ratio of the number of isocyanate groups NCO to the number of NH functions borne, respectively, by all of the isocyanates (as notably regards the polyurethane bearing NCO end groups and optionally the polyurethane P1), and aminosilanes present in the medium of step E2.

The ratio r2 preferably ranges from 1.5 to 5.2 and more preferentially from 1.5 to 4.5.

The polyaddition reaction of step E2 may be performed in the presence or absence of at least one reaction catalyst.

The catalyst may be any catalyst known to a person skilled in the art. An amount ranging up to 0.3% by weight of catalyst(s), relative to the weight of the reaction medium of step E2, may be used.

The reaction of step E2 may also be performed in the presence of a solvent. The solvent may be chosen from the group consisting of esters, ketones and aromatic compounds, and mixtures thereof. The solvent may be added during step E1, during step E2 or may come from the starting reagents dissolved in said solvent. The solvent may be chosen, for example, from ethyl acetate, butyl acetate, acetone, methyl ethyl ketone, methyl isobutyl ketone, toluene, xylene and mixtures thereof.

Step E2 preferably leads to a composition comprising at least one polyurethane P2 as described in the present patent application, in admixture with other polymer(s), for instance a polymer terminated with at least two OH functions.

### Aminosilane

The aminosilanes notably contain an amine function as a function that is reactive with the —NCO function of the polyurethane P1 obtained on conclusion of step E1.

The aminosilane preferably has the formula (I) below:

(R⁴O)₃₋ᵣ(R³)ᵣSi—R¹—NH—R² (1)

in which:
R³, which may be identical or different, each represents a linear or branched monovalent hydrocarbon-based radical comprising from 1 to 10 carbon atoms;
R⁴, which may be identical or different, represents a linear or branched monovalent hydrocarbon-based radical comprising from 1 to 10 carbon atoms;
or two groups R⁴ can form a ring;
r is an integer equal to 0, 1 or 2, preferably equal to 0 or 1 and even more preferentially equal to 0;
R¹ represents a linear or branched divalent alkylene radical comprising from 1 to 12 carbon atoms, preferably from 1 to 6 carbon atoms, R³ preferentially representing methylene or n-propylene, and
R² represents H, a linear or branched alkyl radical, an arylalkyl radical, a cyclic radical comprising from 1 to 20 carbon atoms, or a radical having the formula (II) below:

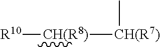

in which:
   R⁷ and R⁸ are, independently of each other, hydrogen or a radical chosen from the group consisting of —R⁹, —COOR⁹ and —CN;
   the radical R¹⁰ is hydrogen, or a radical chosen from the group consisting of —CH₂—COOR⁹, —COOR⁹, —CONHR⁹, —CON(R⁹)₂, —CN;
   the radical R⁹ being a hydrocarbon-based radical containing from 1 to 20 carbon atoms optionally comprising at least one heteroatom.

In particular, the radical of formula (II) may be chosen from one of the following radicals:

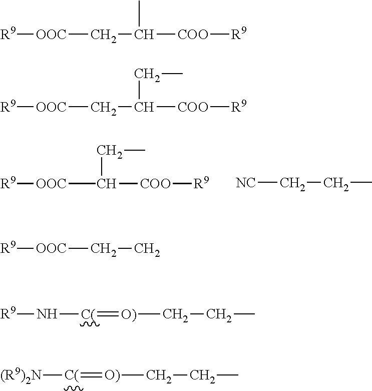

in which R⁹ is as defined previously.

According to a preferred embodiment, the aminosilane of formula (I) is that in which:
R³, which may be identical or different, each represents a linear or branched alkyl group comprising from 1 to 10 carbon atoms, preferably from 1 to 5 carbon atoms;
R⁴, which may be identical or different, each represents a linear or branched alkyl group comprising from 1 to 10 carbon atoms, preferably from 1 to 5 carbon atoms,
r is an integer equal to 0, 1 or 2, and preferably p is 0;
R¹ represents a linear or branched divalent alkylene radical comprising from 1 to 12 carbon atoms, preferably from 1 to 6 carbon atoms, R¹ preferentially representing n-propylene, and
R² represents H.

The aminosilanes of formula (I) above are preferably primary aminosilanes, for instance 3-aminopropyltrimethoxysilane, 3-aminopropyltriethoxysilane, 3-aminopropyldiethoxymethylsilane, 3-aminopropyldimethoxymethylsilane; secondary aminosilanes, for instance N-butyl-3-aminopropyltrimethoxysilane, N-butyl-3-aminopropyltriethoxysilane, N-phenyl-3-aminopropyltrimethoxysilane, N-phenyl-3-aminopropyltriethoxysilane; the reaction products of the Michael addition of primary aminosilanes, for instance 3-aminopropyltrimethoxysilane or 3-aminopropyldimethoxymethylsilane with Michael acceptors, for instance acrylonitrile, acrylic esters, acrylamides, maleic diesters, methylene malonate diesters, itaconic diesters.

Preferably, the aminosilane is 3-aminopropyltriethoxysilane.

The aminosilanes may be commercially available, for instance Dynasylan® 1189 sold by Evonik, or Silquest® A1110 sold by Momentive.

### Polyurethane Base Polyester Polyol P2

The —OH component may comprise from 20% to 10% by weight, preferably from 30% to 90% by weight, more preferentially from 40% to 80% by weight of polyurethane(s) P2 (dry extract) relative to the total weight of said-OH component.

The polyurethane P2 may be a single polymer or a polymer blend.

The polyurethane P2 may have a mass content of OH groups ranging from 0.10% to 0.5% by weight, preferably from 0.1% to 0.4% by weight, relative to the total weight of the polyurethane P2.

The —OH component may have a viscosity at 23° C. ranging from 500 mPa·s to 2500 mPa·s or a solids content of 60%.

### Composition

The adhesive composition according to the invention is a multi-component composition comprising at least the abovementioned —NCO and —OH components. Preferably, the adhesive composition is a two-component composition.

The amounts of the —NCO and —OH components in said composition may be such that the —NCO/—OH equivalent mole ratio is within a range from 1.2 to 5.0, preferably from 1.5 to 3.0 and even more preferentially from 1.5 to 2.5.

The term “—NCO/—OH equivalent mole ratio” means the ratio of the equivalent number of —NCO groups (present in the —NCO component) to the equivalent number of —OH groups (present in the —OH component).

The adhesive composition may comprise at least one additive chosen from the group consisting of plasticizers, catalysts, rheological agents, solvents, pigments, adhesion promoters, moisture absorbers, UV stabilizers (or antioxidants), dyes, fillers, and mixtures thereof. These additives may be found in the —NCO component, in the —OH component or in both.

When the adhesive composition is solvent-based, this means that it comprises at least one solvent.

Preferably, the composition does not comprise any epoxy compounds (i.e. compounds comprising at least one epoxy function).

### Uses

A subject of the present invention is also a multilayer (complex) structure comprising at least two layers of material bonded together by an adhesive layer, characterized in that said adhesive layer consists of the composition according to the invention in the crosslinked state.

The adhesive layer preferably has a thickness ranging from 1.2 to 5 μm.

The adhesive layer may be obtained by crosslinking the composition according to the invention in an amount preferably ranging from 0.5 to 5 g/m².

The materials of which the layers of material surrounding the adhesive layer are made are generally chosen from paper, metal, for instance aluminum, or thermoplastic polymers such as:
polyethylene (PE),
polypropylene (PP),
a copolymer based on ethylene and on propylene,
polyamide (PA),
polyethylene terephthalate (PET), or also
a copolymer based on ethylene, for instance a maleic anhydride-grafted copolymer, a copolymer of ethylene and of vinyl acetate (EVA), a copolymer of ethylene and of vinyl alcohol (EVOH), a copolymer of ethylene and of an alkyl acrylate such as methyl acrylate (EMA) or butyl acetate (EBA),
polystyrene (PS),
polyvinyl chloride (PVC),
polyvinylidene fluoride (PVDF),
a polymer or copolymer of lactic acid (PLA), or
a polyhydroxyalkanoate (PHA).

An individual layer of material may itself consist of several materials. It may be, for example, a layer of thermoplastic polymers obtained by coextrusion of two polymers (there is then no adhesive between the coextruded layers), the individual layers of thermoplastic polymer may also be coated with a substance (for example based on aluminum oxide or silicon oxide) or metallized (in the case of PET metallized with aluminum particles) to add an additional barrier effect.

The thickness of the two layers of material adjacent to the adhesive layer and of the other layers of material used in the multilayer structure according to the invention may vary within a wide range extending, for example, from 5 to 150 μm. The total thickness of said structure may also be liable to vary within a wide range extending, for example, from 20 to 400 μm.

Preferably, the multilayer structure is in the form of a multilayer film.

According to a preferred variant, the film comprises from two to four thin layers of materials, said film then being respectively denoted two-layer, three-layer or four-layer.

According to one embodiment, said film is chosen from:
a three-layer film: PET/ALU/PE (bioriented polyester)
a three-layer film: PET/ALU/cPP (“cast” polypropylene).

A subject of the invention is also a process for manufacturing the multilayer (complex) structure according to the invention, comprising the following steps:
mixing the —OH and —NCO components and optionally diluting with an organic solvent to form an adhesive mixture, and then
coating said adhesive mixture over the surface of a first layer of material, and then
optional evaporation of the organic solvent in case where a solvent is present;
laminating the surface of a second layer onto the surface coated with the first layer of material, and then
crosslinking said adhesive mixture.

The adhesive composition is typically supplied to the laminator in the form of two compositions (or components):
one (known as —NCO component) comprising chemical species bearing isocyanate-NCO end groups, and
the other (known as —OH component) comprising chemical species bearing hydroxyl-OH end groups.

The mixing of these two components may be performed at 23° C. if the composition is solvent-based, otherwise between 35 and 60° C., by the operator of the laminating machine prior to its start-up, which enables correct functioning thereof, by virtue of an appropriate viscosity. The viscosity of the adhesive composition thus obtained may be adjusted by simple addition of solvent by the operator when it is solvent-based, resulting in a final amount of dry extract of the adhesive composition which may range in practice from 30% to 70% on a weight/weight basis, preferably from 30% to 55% on a weight/weight basis; otherwise by adjusting the application temperature.

Said mixture may be coated onto all or part of the surface of a material. In particular, said mixture may be coated in the form of a layer with a thickness ranging from 1.5 to 5 μm. The coating is preferably performed continuously or substantially continuously.

The coating and laminating of the second material are generally performed within a time interval that is compatible with the coating process, as is well known to a person skilled in the art, that is to say before the adhesive layer loses its ability to attach the two materials by adhesive bonding.

Optionally, the crosslinking of said mixture on the surface of the material can be accelerated by heating the coated material(s) to a temperature of less than or equal to 70° C. The time required to complete this crosslinking reaction and thus to ensure the required level of cohesion is generally of the order of 0.5 to 24 hours.

The invention also relates to the use of the multilayer (complex) structure according to the invention for the manufacture of flexible packagings. Specifically, the complexes according to the invention may be used for the manufacture of very varied flexible packagings, which are formed and then closed (after the step of packaging the product intended for the consumer) via heat-sealing (or heat-welding) techniques.

Preferably, the complex according to the invention is used in food packaging. The packagings intended for foodstuffs may be heat-treated at temperatures ranging from 90° C. to 135° C. before use.

The multilayer structure is advantageously suitable for manufacturing flexible packagings intended for packaging food products.

The adhesive composition according to the invention has at least one of the following advantages:
it advantageously leads (without aging), after crosslinking, to a multilayer structure that has good initial adhesion. Preferably, the initial peel strength is greater than or equal to 3 N/15 mm, even more preferentially greater than or equal to 4.0 N/15 mm, for a PET/ALU/cPP three-layer film according to the method described in the experimental section;
after aging over time of the composition, it advantageously leads, after crosslinking, to a multilayer structure that has good initial adhesion. Preferably, the initial peel strength is greater than or equal to 3 N/15 mm, even more preferentially greater than or equal to 4.0 N/15 mm, for a PET/ALU/cPP three-layer film according to the method described in the experimental section;
it advantageously leads (without aging), after crosslinking, to a multilayer structure that has good resistance to heat treatment, preferably good heat resistance with respect to sterilization and/or pasteurization testing. Preferably, the peel strength 1 hour after sterilization is greater than or equal to 3 N/15 mm, even more preferentially greater than or equal to 4.0 N/15 mm, for a PET/ALU/cPP three-layer film according to the method described in the experimental section;
after aging over time of the composition, it advantageously leads, after crosslinking, to a multilayer structure with good resistance to heat treatment, preferably good heat resistance with respect to sterilization and/or pasteurization testing. Preferably, the peel strength 1 hour after sterilization is greater than or equal to 3 N/15 mm, even more preferentially greater than or equal to 4.0 N/15 mm, for a PET/ALU/cPP three-layer film according to the method described in the experimental section;
it advantageously leads to a low variation in adhesion performance before/after sterilization on an aged and non-aged adhesive;
it is crosslinkable at 23° C. for less than 5 days, preferentially less than 3 days;
its viscosity is stable over time;
it has a reduced content of residual monomers;
it does not generate aromatic amines (PAA) after migration within the packaging;
it complies with the regulations specific to food packaging that is sterilizable.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range in which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

The following compounds were used in the examples:
Isophorone diisocyanate (IPDI) available from Vencorex. Its functionality is equal to 2 and its NCO percentage 37.6%;
Takenate D-110N (NB) sold by the company Mitsui Chemicals, corresponding to an m-XDI/TMP (meta-xylylene diisocyanate and trimethylolpropane) adduct at 75% solids in ethyl acetate (the NCO percentage is 11% to 12%);

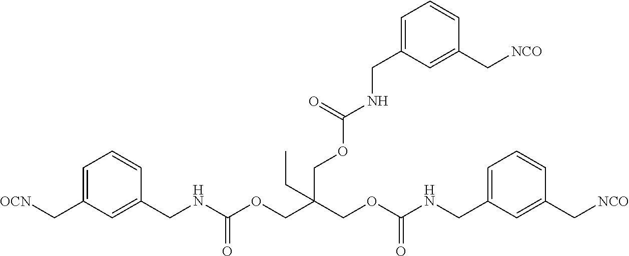

Silquest A-1110, available from Momentive, is 3-aminopropyltrimethoxysilane (molar mass=179 g/mol);
Monoethylene glycol, available from BASF;
Diethylene glycol, available from Sabic;
Tyzor® LA available from Dorf Ketal: titanium chelate
Tyzor® TnBT available from Dork Ketal: (nBuO) 4Ti

### Example 1: Preparation of Linear Amorphous Copolyester Diol (COPO1)

35.120 g of monoethylene glycol and 154.435 g of diethylene glycol are placed in a closed 1 liter reactor which is equipped with a stirrer, a distillation column, heating means and a thermometer and which is connected to a vacuum pump.

When the temperature of the reaction mixture reaches 120° C., the following are introduced into the reactor: 76.190 g of adipic acid, 170.035 g of isophthalic acid, 64.165 g of terephthalic acid and 0.035 g of a catalyst based on a titanium chelate (Tyzor® LA from the company Dorf Ketal).

Next, a temperature gradient is programmed so as to reach a temperature of 230° C. in 3 h. The acid number (Na) is then measured. The reaction is stopped when the acid number Na is less than 25 mg KOH/g. 0.020 g of a titanium-based catalyst (of formula (nBuO) 4Ti, Tyzor® TnBT from the company Dorf Ketal) is then introduced, and the reactor is then placed under vacuum and the reaction mixture is heated to 240° C.

Measurements are taken of the acid number Na according to the standard ASTM-D4662 and of the Brookfield viscosity at 180° C. The reaction is stopped when the Na is less than 3 mg KOH/g and when the viscosity is between 8000 and 9000 mPa·s.

The copolyester polyol obtained is subsequently cooled to 200° C. and is then poured slowly into ethyl acetate at room temperature (23° C.) with stirring, to form a 60% weight/weight solution.

The NOH of the copolyester diol thus obtained was measured according to the standard ISO 14900:2017 and is equal to 12.5 mg KOH/g. The Brookfield viscosity at 23° C. of the product obtained is 2000 mPa·s.

The viscosity measurement may be performed using a Brookfield viscometer according to the standard ISO 2555:2018.

### Example 2: Preparation of the Linear Amorphous Copolyester Diol (COPO2)

7.669 g of monoethylene glycol and 202.245 g of diethylene glycol are placed in a closed 1 liter reactor which is equipped with a stirrer, a distillation column, heating means and a thermometer and which is connected to a vacuum pump.

When the temperature of the reaction mixture reaches 120° C., the following are introduced into the reactor: 95.555 g of adipic acid and 194.480 g of isophthalic acid.

Next, a temperature gradient is programmed so as to reach a temperature of 230° C. in 3 h. The acid number (Na) is then measured. The reaction is stopped when the acid number Na is less than 25 mg KOH/g.

0.051 g of a titanium-based catalyst (Tyzor® TnBT) is then introduced, and the reactor is then placed under vacuum (15 mbar reached in 2 h) and the reaction mixture is heated to 240° C.

Measurements are taken of the Na and of the Brookfield viscosity at 80° C. The reaction is stopped when the Na is less than 3 mg KOH/g and when the viscosity is between 6000 and 6500 mPa·s.

The copolyester polyol obtained is subsequently cooled to 200° C. and is then poured slowly into ethyl acetate at room temperature with stirring, to form a 75% weight/weight solution.

The NOH of the copolyester diol thus obtained was measured and is equal to 42.5 mg KOH/g. The Brookfield viscosity at 23° C. of the product obtained is 1100 mPa·s.

### Example 3: Preparation of —OH Components (3A, 3B, 3C)

### —OH Component 3A:

213.075 g of copolyester COPO1 (Example 1), 213.080 g of copolyester COPO2 (Example 2) and 10.565 g of isophorone diisocyanate (IPDI) are placed in a 1-liter closed reactor equipped with a stirrer, a condenser, heating means and a thermometer.

The mixture is then heated to a temperature of 77° C. and maintained at this temperature for 13 hours.

The reaction progress is monitored by measuring the content of NCO groups by back titration of dibutylamine using hydrochloric acid, according to the standard NF T52-132. When the measured content of NCO groups is approximately equal to the desired content of NCO groups (0.25-0.46% NCO), the mixture is cooled to 55° C. and 4.637 g of the aminosilane Silquest® A1110 are then added. This addition is performed before all NCO functions on the intermediate prepolymer have disappeared, so that the aminosilane is grafted onto the prepolymer. The reaction mixture is stirred for 3 hours at this temperature.

Ethyl acetate (a non-reactive solvent) is then added until a solids content of 60% is obtained. Ethyl acetate does not participate in the reaction and acts as a diluent. After homogenizing the mixture (30 minutes) maintained at 30-50° C., the Brookfield viscosity at 23° C. and the solids content are measured.

### —OH Component 3B:

190.155 g of copolyester COPO2 (Example 2) and 7.495 g of isophorone diisocyanate (IPDI) are placed in a 1-liter closed reactor equipped with a stirrer, a condenser, heating means and a thermometer.

The mixture is then heated to a temperature of 77° C. and maintained at this temperature for 10 hours.

When the measured content of NCO groups is approximately equal to the desired content of NCO groups (0.28-0.71% NCO), the mixture is cooled to 55° C. and 2.34 g of the aminosilane Silquest® A1110 are then added. This addition is performed before all NCO functions on the intermediate prepolymer have disappeared, so that the aminosilane is grafted onto the prepolymer. The reaction mixture is stirred for 3 hours at this temperature.

249.982 g of copolyester COPO1 (Example 1) and ethyl acetate (non-reactive solvent) are then added until a solids content of 60% is obtained. Ethyl acetate and COPO1 do not participate in the reaction and have a role as diluents in this step. After homogenizing the mixture (30 minutes) maintained at 30-50° C., the Brookfield viscosity at 23° C. and the solids content are measured.

### —OH Component 3C:

63.599 g of COPO1 copolyester (Example 1), 254.457 g of COPO2 copolyester (Example 2) and 10.614 g of isophorone diisocyanate (IPDI) are placed in a 1-liter closed reactor equipped with a stirrer, a condenser, heating means and a thermometer.

The mixture is then heated to a temperature of 77° C. and maintained at this temperature for 13 hours.

When the measured content of NCO groups is approximately equal to the desired content of NCO groups (0.27-0.61% NCO), the mixture is cooled to 55° C. and 3.722 g of the aminosilane Silquest® A1110 are then added. This addition is performed before all NCO functions on the intermediate prepolymer have disappeared, so that the aminosilane is grafted onto the prepolymer. The reaction mixture is stirred for 3 hours at this temperature.

99.983 g of copolyester COPO1 (Example 1) and ethyl acetate (non-reactive solvent) are then added until a solids content of 60% is obtained. Ethyl acetate and COPO1 do not participate in the reaction and have a role as diluents in this step. After homogenizing the mixture (30 minutes) maintained at 30-50° C., the Brookfield viscosity at 23° C. and the solids content are measured.

The compositions of the various-OH components are detailed in the table below:

TABLE 1
Compositions of the —OH components

| | | OH (3A) | OH (3B) | OH (3C) |
|---|---|---|---|---|
| | | (% by | (% by | (% by |
| | —OH component | weight) | weight) | weight) |
| Synthesis of | Copolyester COPO1 | 42.61 | — | 12.72 |
| polyurethane | (Example 1) | | | |
| P2 | Copolyester COPO2 | 42.61 | 38.03 | 50.89 |
| | (Example 2) | | | |
| | IPDI | 2.11 | 1.50 | 2.12 |
| | Silquest ® A1110 | 0.93 | 0.47 | 0.75 |
| Non-reactive | Ethyl acetate | 11.74 | 10.00 | 13.53 |
| solvents added | (solvent) | | | |
| at the end of | Copolyester COPO1 | 0 | 50.00 | 20.00 |
| synthesis | (Example 1) (solids | | | |
| | content = 60% in | | | |
| | ethyl acetate) | | | |

| | | | |
|---|---|---|---|
| Solids content | 59.93% | 60.03% | 59.05% |
| % OH of P2 | 0.187% | 0.139% | 0.197% |
| % OH of the —OH component | 0.187% | 0.253% | 0.243% |
| NCO/OH (molar) synthesis of P2 | 0.63 | 0.62 | 0.62 |

The solids content (before or after aging) is measured by weighing three samples of exactly about 1 g each before and after evaporation of the solvent in an oven at 105° C. for 3 hours.

Aging of the —OH components

Each of the —OH components of Example 3, which are liquid, were placed in an oven at 40° C. for 21 days, in a sealed metal pot inertized with nitrogen. This accelerated aging of the —OH component corresponds approximately to 4 to 5 months of storage at 23° C. It therefore allows simulation of storage of the —OH component prior to use by the user.

The viscosity at 23° C. is measured using a Brookfield viscometer according to the standard ISO 2555 published in 1999 (Brookfield RVT viscometer, with a needle suitable for viscosity range 3 and a rotation speed of 50 revolutions per minute (rpm)).

The viscosity and solids content results are given in the following table:

| | OH (3A) | OH (3B) | OH (3C) |
|---|---|---|---|
| Initial viscosity of the —OH | 1264 | 908 | 748 |
| component at 23° C. (mPa · s) | | | |
| Initial solids content of the —OH | 59.93% | 60.03% | 59.05% |
| component (%) | | | |
| | aged OH | aged OH | aged OH |
| | (3A) | (3B) | (3C) |
| Viscosity of the —OH component at | 1980 | 968 | 938 |
| 23° C. after aging for 21 days at | | | |
| 40° C. (mPa · s) | | | |
| Solids content of the —OH | 59.95% | 59.43% | 59.16% |
| component after aging for 21 days | | | |
| at 40° C. | | | |

### Example 4: Preparation of the Comparative —OH Component (4A)

### —OH Component 4A:

371.9 g of copolyester COPO2 (Example 2) and 14.235 g of isophorone diisocyanate (IPDI) are placed in a 1-liter closed reactor equipped with a stirrer, a condenser, heating means and a thermometer.

The mixture is then heated to a temperature of 77° C. and maintained at this temperature for 13 hours.

When the measured content of NCO groups is approximately equal to zero (NCO groups consumed), the mixture is cooled to 55° C. and 4.615 g of the aminosilane Silquest® A1110 are then added. The aminosilane will not react because there are no NCO functions present, as they have all been consumed, and so the aminosilane will not graft onto the polymer.

Ethyl acetate (a non-reactive solvent) is then added until a solids content of 60% is obtained. Ethyl acetate does not participate in the reaction and acts as a diluent. After homogenizing the mixture (30 minutes) maintained at 30-50° C., the Brookfield viscosity at 23° C. and the solids content are measured.

The composition of the —OH component is detailed in the table below:

TABLE 2
Compositions of the comparative —OH component (4A)

| | | Comparative |
|---|---|---|
| | | —OH (4A) |
| | —OH component | (% by weight) |
| Synthesis of the | Copolyester COPO2 | 74.38 |
| polyurethane | (Example 2) | |
| prepolymer | IPDI | 2.85 |
| Non-reactive solvents | Ethyl acetate (solvent) | 21.85 |
| added at the end of | Silquest ® A1110 | 0.92 |
| synthesis | | |

| | |
|---|---|
| Solids content | 61.46% |
| % OH prepolymer | 0.285% |
| % OH of the —OH component | 0.285% |
| NCO/OH (molar) synthesis of the prepolymer | 0.60 |

### Aging of the Comparative —OH Component

The —OH component of Example 4, which is liquid, was placed in an oven at 40° C. for 21 days, in a sealed metal container inertized with nitrogen. This accelerated aging of the —OH component corresponds approximately to 4 to 5 months of storage at 23° C. It therefore allows simulation of storage of the —OH component prior to use by the user.

The viscosity at 23° C. is measured using a Brookfield viscometer according to the standard ISO 2555 published in 1999 (Brookfield RVT viscometer, with a needle suitable for viscosity range 3 and a rotation speed of 50 revolutions per minute (rpm)).

The viscosity and solids content results are given in the following table:

| | Comparative —OH (4A) |
|---|---|
| Initial viscosity of the —OH | 1085 |
| component at 23° C. (mPa · s) | |
| Initial solids content of the —OH | 61.46% |
| component (%) | |

| | Aged |
|---|---|
| | comparative |
| | —OH (4A) |
| Viscosity of the —OH component at | 985 |
| 23° C. after aging for 21 days at | |
| 40° C. (mPa · s) | |
| Solids content of the —OH component | 60.92% |
| after aging for 21 days at 40° C. | |

### Examples 5 to 12: Two-Component Adhesive Compositions

An —OH component of Example 3 (3A, 3B, 3C, aged or not) or the —OH component of Comparative Example 4 (4A, aged or not) was mixed with the —NCO component using ethyl acetate as solvent to fluidize the adhesive mixture and to obtain a solids content of 35%, then introduced into the feed tank of the laminating machine at room temperature (23° C.) in a given weight ratio to achieve a given NCO/OH mole ratio.

The —NCO component is as follows:

| | |
|---|---|
| Takenate D-110N | 100.00% |
| m-XDI/TMP adduct (in ethyl acetate, solids | |
| content = 75%) | |
| Solids content | 75.00% |
| Theoretical % NCO | 11.50% |

The data for the two-component adhesive compositions are given in Table 3.

Similar two-component compositions were prepared with the —OH components of Examples 3 and 4 obtained after aging, in ratios identical to those mentioned for the non-aged-OH components.

TABLE 3
Two-component adhesive compositions

| | | | | | | | Ex. 11 | Ex. 12 |
|---|---|---|---|---|---|---|---|---|
| | Ex. 5 | Ex. 6 | Ex. 7 | Ex. 8 | Ex. 9 | Ex. 10 | (comparative) | (comparative) |
| —OH component | 3A | 3B | 3C | aged 3A | aged 3B | aged 3C | 4A | aged 4A |
| —NCO component | Takenate | Takenate | Takenate | Takenate | Takenate | Takenate | Takenate | Takenate |
| | D110N | D110N | D110N | D110N | D110N | D110N | D110N | D110N |
| Solvent | Ethyl | Ethyl | Ethyl | Ethyl | Ethyl | Ethyl | Ethyl | Ethyl |
| | acetate | acetate | acetate | acetate | acetate | acetate | acetate | acetate |
| —NCO/—OH | 1.99 | 1.75 | 1.78 | 1.99 | 1.75 | 1.78 | 1.79 | 1.79 |
| equivalent | | | | | | | | |
| mole ratio | | | | | | | | |
| —NCO/—OH | 8/100 | 9.5/100 | 9.3/100 | 8/100 | 9.5/100 | 9.3/100 | 11/100 | 11/100 |
| component | | | | | | | | |
| weight ratio | | | | | | | | |

### Example 13: PET/ALU/cPP Three-Layer Film

A three-layer film consisting of a first film made of PolyEthyleneTerephthalate (PET), of a second film made of aluminum (ALU) and of a third film made of cast PolyPropylene (cPP), which are bonded at each interface with a layer of adhesive composition of Examples 5 to 12, is prepared.

A 12 μm-thick PET film, an 8 μm-thick ALU film and a 70 μm-thick cPP film are used.

This three-layer film is obtained in two steps:
The manufacture of a PET/ALU two-layer film by feeding a Nordmeccanica-type laminating machine with a standard two-component adhesive composition sold by Bostik: Herberts HP 1614+Purbinder C1. Said laminating machine is equipped with a roller-type coating device with an open tray, operating at room temperature and at a throughput speed of 50 m/minute. The adhesive layer bonding the two PET/ALU films has a thickness of about 3.5 μm, corresponding to about 3.5 g/m² of adhesive composition.
The manufacture of the PET/ALU/cPP three-layer film is completed by coating the PET/ALU two-layer film, on the ALU side, using a hand coater, with the two-component adhesive composition according to the invention, for each of Examples 5 to 10, and the comparative adhesive composition of Examples 11 and 12, and then laminating the cPP film, which is done manually by applying a 2 kg roller.
   Immediately after manufacture, the three-layer film is stored at a temperature of 23° C. and under an atmosphere with a relative humidity (RH) of 50%. The samples are subsequently subjected to the following tests after 2 days of crosslinking under these conditions: 23° C., 50% RH.

### A. 180° Peel Test

The 180° peel test is as described in the French standard NF T 54-122. The principle of this test consists in determining the force necessary to separate (or peel) two individual layers of films bonded by the two-component adhesive. A test specimen of rectangular shape, with a width of 15 mm and a length of approximately 10 cm, is cut out of the three-layer film. The two individual layers of film included in this strip are manually detached from the end of this test specimen, over approximately 2 cm, and the two free ends thus obtained are attached to two holding devices respectively connected to a stationary part and a movable part of a tensile testing device which are located on a vertical axis. While a drive mechanism imparts a uniform speed of 100 mm/minute to the movable part, resulting in the detachment of the two layers, the detached ends of which gradually move along a vertical axis with the formation of an angle of 180°, the stationary part-connected to a dynamometer-measures the force which is withstood by the test specimen thus held and which is expressed in N/15 mm.

On the PET/ALU/cPP three-layer film, the peel test was performed only between ALU and cPP.

### B. Resistance to Sterilization

The resistance to sterilization is then evaluated on bag-type samples after 2 days of crosslinking at 23° C. and 50% RH. The bags were manufactured from the A4-sized three-layer film (dimensions 21×29.7 cm) obtained by hand coating, in which two rectangular formats measuring 14×12 cm were cut out using a template. These two formats are then superposed cPP against cPP and heat-sealed on three sides at a temperature of 160° C. and a pressure of 3 bar for 1 second.

3 grams of distilled water are then added to each bag, from which the air is manually expelled by pressing the packaging before heat-sealing the fourth and final side of each bag according to the parameters stated previously.

This sample is placed in an autoclave which is heated at 135° C. in the vapor phase for one hour in order to simulate a sterilization treatment. The sample is then kept at room temperature for 1 hour, after which the cohesion of the ALU/cPP interface of the film is measured by means of the 180° C. peel test described previously. The result is indicated in N/15 mm in the results tables for each of the adhesive compositions 5 to 12, before and after aging of the —OH component.

### C. Results:

The compositions of Examples 5 to 10 (according to the invention) are advantageously compliant with the European (EU 10/2011) and American (FDA 177.1390) regulations, in that they do not comprise any aromatic isocyanate monomers and have an amount of PAA (primary aromatic amines) of less than 2 ppb (Europe) for food packagings.

In addition, the performance of the compositions of Examples 5 to 10 (invention) and 11-12 (comparative) is detailed in the table below:

| (PET/ALU)/cPP | | | | | | | F7 | F8 |
|---|---|---|---|---|---|---|---|---|
| Three-layer film | F1 | F2 | F3 | F4 | F5 | F6 | (comparative) | (comparative) |
| Adhesive used at the | Ex. 5 | Ex. 6 | Ex. 7 | Ex. 8 | Ex 9 | Ex 10 | Ex 11 | Ex 12 |
| ALU/cPP interface | | | | | | | | |
| Initial peel strength at | 4.83 | 5.5 | 3.69 | 4.36 | 4.57 | 4.43 | 3.69 | 3.11 |
| the ALU/cPP interface | | | | | | | | |
| on adhesive with non- | | | | | | | | |
| aged^{a)} or aged^{b)} —OH | | | | | | | | |
| component (N/15 mm) | | | | | | | | |
| Initial peel strength 1 h | 4.42 | 4.99 | 4.36 | 4.39 | 4.42 | 4.69 | 2.38 | 1.94 |
| after sterilization at the | | | | | | | | |
| ALU/cPP interface on | | | | | | | | |
| adhesive with non- | | | | | | | | |
| aged^{a)} —OH component | | | | | | | | |
| (N/15 mm) | | | | | | | | |
| % variation in peel | −8% | −9% | +18% | +1% | −3% | +6% | −36% | −38% |
| strength 1 h after | | | | | | | | |
| sterilization on | | | | | | | | |
| adhesive with non-aged^{a)} | | | | | | | | |
| or aged^{b)} —OH component | | | | | | | | |

^{a)}The non-aged —OH component corresponds to the —OH component (3A) for film F1, the —OH component (3B) for film F2, the —OH component (3C) for film F3, and the comparative —OH component (4A) for film F7.
^{b)}The aged —OH component corresponds to the aged —OH component (3A) for film F4, the aged —OH component (3B) for film F5, the aged —OH component (3C) for film F6, and the aged comparative —OH component 4A for film F8.

The results show that films F1, F2, F3, F4, F5, and F6 advantageously have an initial peel strength greater than 3 N/15 mm for adhesives with an aged or non-aged-OH component. More particularly, the adhesives of Examples 5 to 10 according to the invention advantageously lead to good resistance to sterilization, whether for adhesives having a non-aged-OH component (4.42/4.99/4.36 N/15 mm) or with an aged-OH component (4.39/4.42/4.69 N/15 mm).

The percentage variation in peel strength 1 h after sterilization on adhesive with —OH components that have undergone accelerated aging advantageously ranges from −3% to +6% (films F4, F5, and F6 according to the invention), which demonstrates a very small variation. Thus, adhesives that have undergone accelerated aging as described above advantageously maintain good resistance to sterilization and thus good adhesive properties. This is important for the end user, who can advantageously use a two-component adhesive composition stored for a few months before use.

In contrast, films F7 and F8 (comparative) lead to much higher variations (−36% and −38%, respectively).

1-16. (canceled)

17. An adhesive composition comprising an —OH component and an —NCO component, characterized in that:
the —NCO component is a composition comprising at least one polyisocyanate;
the —OH component is a composition comprising at least one polyurethane P2 comprising at least one hydroxyl terminal function and at least one silyl terminal function.

18. The adhesive composition as claimed in claim 17, characterized in that the polyurethane P2 is a polyester polyol-based polyurethane.

19. The adhesive composition as claimed in claim 17, characterized in that the polyisocyanate is a triisocyanate.

20. The adhesive composition as claimed in claim 17, characterized in that the polyisocyanate is the adduct of m-XDI and of trimethylolpropane (TMP).

21. The adhesive composition as claimed in claim 17, characterized in that the polyurethane P2 is obtained via a process comprising the following steps:
E1) the preparation of a composition comprising at least one polyurethane P1 comprising at least one-NCO terminal function and at least one-OH terminal function, by a polyaddition reaction of:
i) at least one polyester polyol A1;
ii) at least one polyisocyanate P′;
iii) an optional polyol A2 different from A1;
in amounts such that the NCO/OH mole ratio (r1) is less than 1;
E2) reacting the composition formed in step E1 with at least one aminosilane.

22. The adhesive composition as claimed in claim 21, characterized in that the polyester polyol A1 is a copolyester obtained by polycondensation reaction:
of at least one aliphatic diol (a); with
at least one aromatic diacid (b) chosen from terephthalic acid, isophthalic acid, phthalic acid and a diester or anhydride derivative thereof; and mixtures thereof; and
at least one aliphatic diacid (c) or a diester or anhydride derivative thereof.

23. The adhesive composition as claimed in claim 21, characterized in that the polyester polyol A1 is obtained by polycondensation:
of two aliphatic diols (a) consisting, respectively, of ethylene glycol and diethylene glycol; with
either two diacids (b) consisting, respectively, of terephthalic acid and isophthalic acid; or isophthalic acid as acid b); and
adipic acid as aliphatic diacid (c).

24. The adhesive composition as claimed in claim 21, characterized in that the ratio r1 ranges from 0.25 to 0.95.

25. The adhesive composition as claimed in claim 21, characterized in that the polyurethane P1 has a content of NCO groups ranging from 0.10% to 0.90%.

26. The adhesive composition as claimed in claim 21, characterized in that the NCO/NH mole ratio (r2) ranges from 1.5 to 5.2.

27. The adhesive composition as claimed in claim 21, characterized in that the polyurethane P2 has a mass content of OH groups ranging from 0.10% to 0.50% by weight, relative to the total weight of the polyurethane P2.

28. The adhesive composition as claimed in claim 17, characterized in that the —OH component has a viscosity at 23° C. ranging from 500 mPa·s to 2500 mPa·s for a solids content of 60%.

29. The adhesive composition as claimed in claim 21, characterized in that the aminosilane has the formula (I) below:
(R⁴O)₃₋ᵣ(R³)ᵣSi—R¹—NH—R² (I)
in which:
R³, which may be identical or different, each represents a linear or branched monovalent hydrocarbon-based radical comprising from 1 to 10 carbon atoms;
R⁴, which may be identical or different, represents a linear or branched monovalent hydrocarbon-based radical comprising from 1 to 10 carbon atoms; or two groups R⁴ can form a ring;
r is an integer equal to 0, 1 or 2;
R¹ represents a linear or branched divalent alkylene radical comprising from 1 to 12 carbon atoms, and
R² represents H, a linear or branched alkyl radical, an arylalkyl radical, a cyclic radical comprising from 1 to 20 carbon atoms, or a radical having the formula (II) below: 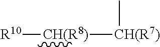
in which:
R⁷ and R⁸ are, independently of each other, hydrogen or a radical chosen from the group consisting of —R⁹, —COOR⁹ and —CN;
the radical R¹⁰ is hydrogen, or a radical chosen from the group consisting of —CH₂—COOR⁹, —COOR⁹, —CONHR⁹, —CON(R⁹)₂, —CN;
the radical R⁹ being a hydrocarbon-based radical containing from 1 to 20 carbon atoms optionally comprising at least one heteroatom.

30. A multilayer structure comprising at least two layers of material bonded together by an adhesive layer, characterized in that said adhesive layer consists of the adhesive composition as claimed in claim 17, in the crosslinked state.

31. A process for manufacturing the multilayer structure as claimed in claim 30, comprising the following steps:
mixing the —OH and —NCO components and optionally diluting with an organic solvent to form an adhesive mixture, and then
coating said adhesive mixture over the surface of a first layer of material, and then
optional evaporation of the organic solvent in case where a solvent is present;
laminating the surface of a second layer onto the surface coated with the first layer of material, and then
crosslinking said adhesive mixture.

32. Use of the multilayer structure as defined in claim 29, for the manufacture of flexible packagings.
